(19) United States
(12) Patent Application Publication
(10) Pub. No.: US 2025/0257194 A1
(43) Pub. Date: Aug. 14, 2025

(54) A METHOD FOR THE PREPARATION OF AN EPOXY RESIN COMPOSITION FOR THE PRE-IMPREGNATION OF MATERIALS

(71) Applicant: Alzchem Trostberg GmbH, Trostberg (DE)

(72) Inventors: Dominik ZGELA, Truchtlaching (DE); Peter DIJKINK, Garching an der Alz (DE); Helga WINTERER, Halsbach (DE)

(73) Assignee: Alzchem Trostberg GmbH, Trostberg (DE)

(21) Appl. No.: 18/997,456

(22) PCT Filed: Jul. 18, 2023
(86) PCT No.: PCT/EP2023/069945

§ 371 Date: Jan. 21, 2025

(30) Foreign Application Priority Data
Jul. 25, 2022 (DE) 10 2022 118 570.2

(51) Int. Cl. C08K 5/55; C08G 59/50; C08G 59/68; C08J 3/20; C08J 5/24; C08L 63/00

(52) U.S. Cl. CPC C08K 5/55; C08G 59/50; C08G 59/686; C08J 3/201; C08J 5/249; C08L 63/00; C08J 2363/02

(57) ABSTRACT

The invention relates to a method for the preparation of an epoxy resin composition for the pre-impregnation of materials, wherein a supplied epoxy resin is heated to a temperature in the range from 60° C. to 100° C. and mixed with a curing agent, curing accelerator, optionally a thickener and a boronic acid of the general formula (I) as polymerization retarder.

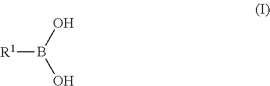

The present invention relates to a method for preparing an epoxy resin composition for pre-impregnation of materials under temperature exposure.

The use of epoxy resins is widespread due to their good chemical resistance, very good thermal and dynamic mechanical properties, and high electrical insulation capacity. These epoxy resins are available in liquid or solid form and can be cured with or without the addition of curing agents, with or without heat input.

Epoxy resins are cured by different mechanisms. In addition to curing with phenols or anhydrides, curing with amines is often carried out. These substances are usually liquid and can usually be mixed very well with epoxy resins. Because of their high reactivity, such epoxy resin compositions are two-component. This means that the resin (A component) and curing agent (B component) are stored separately and mixed in the correct ratio only shortly before use. These two-component resin formulations are also referred to as so-called cold-curing resin formulations, wherein the curing agents used for this purpose are usually selected from the group of amines or amidoamines.

Single-component, heat-curing epoxy resin formulations, on the other hand, are ready-to-use, i.e. epoxy resin and curing agent are mixed at the factory. Mixing errors of the individual components during on-site use are therefore ruled out. The prerequisite for this are latent curing agent systems, which do not react with the epoxy resin at room temperature but readily react when heated, depending on the energy input. In this context, “latent” means that a mixture of the individual components is stable under defined storage conditions.

For such one-component epoxy resin formulations, dicyandiamide, for example, is a particularly suitable and also cost-effective curing agent. Under ambient conditions, corresponding epoxy resin-dicyandiamide mixtures can be stored ready for use for up to twelve (12) months.

In order to lower the reaction temperature for curing single-component epoxy resin formulations, such as epoxy resin-dicyandiamide mixtures, a curing accelerator is usually added to these formulations to lower the activation energy for curing so that curing at lower temperatures is possible. However, these curing accelerators reduce the storage stability of epoxy resin compositions.

Knowing such obstacles, proposals to overcome them have already been published. For example, international patent specification WO 2021/023593 describes the use of boronic acids to increase the storage stability of epoxy resin compositions containing an epoxy resin, a curing agent and a curing accelerator. The epoxy resin compositions are storage stable and allow rapid curing by heating.

Furthermore, the international patent application PCT/EP2022/051177 shows that the use of boronic acids also favors the increase of the storage stability of epoxy resin compositions containing an epoxy resin and a urone. In this context, epoxy resin compositions based on N, N-dimethylurones as curing agents are improved in their storage stability by the addition of boronic acids.

In many cases, to introduce further additives into the epoxy resin, it is necessary to heat the resin to enable or facilitate homogeneous mixing of the additives. The presence of curing accelerators is troublesome here because the accelerators lead to increased reactivity of the epoxy resin composition when temperature is applied. Temperature exposure to epoxy resins is particularly necessary in the production of epoxy resin compositions for prepregs or towpregs, since the viscosity of the epoxy resin composition must be relatively high. If low viscosity epoxy resin compositions are used at room temperature, a thickener usually has to be mixed in. Homogeneous mixing of the epoxy resin with a thickener usually requires heating of the epoxy resin. If the epoxy resin already has a viscosity suitable for the production of prepregs or towpregs, heating of the epoxy resin is necessary in order to mix further necessary additives, such as curing agents, reaction accelerators or polymerization retarders, with the resin.

The viscosity is adjusted in particular by adding different resins of higher viscosity or powder additives. If the viscosity of the epoxy resin composition is increased, the dispersibility of the epoxy resin composition decreases. Thus, the temperature must be increased to decrease the viscosity. In this case, epoxy resin compositions for optimum formulation of all components, such as different epoxy resins of various viscosities, curing agents, curing accelerators and other additives, are exposed to elevated temperatures for several hours. These are then applied to reinforcing fibers, such as carbon, glass or basalt fibers, at elevated temperatures.

The present invention is therefore based on the problem of providing a method for the production of an epoxy resin composition suitable for the production of materials (e.g. prepregs or towpregs) pre-impregnated with the resin composition. In this context, the curing agent, the curing accelerator and other additives should be easily incorporated into the epoxy resin composition, while maintaining the property profile of the composition necessary for prepreg or towpreg production.

The problem is solved by a method for preparation of an epoxy resin composition for pre-impregnation of materials, which is characterized in that a supplied epoxy resin
a) is heated to a temperature in the range of 60° C. to 100° C. and
b) a boronic acid of the general formula (I) is mixed with the epoxy resin as a polymerization retarder

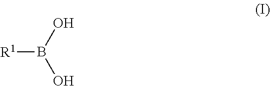

wherein residue R¹ is:
R¹=alkyl, hydroxyalkyl or a residue of formula (II), wherein formula (II) is:

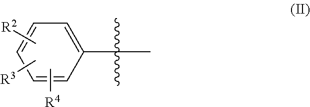

wherein R², R³, R⁴ independently of one another mean, and at least one residue R², R³, R⁴ is not hydrogen:
R², R³, R⁴=hydrogen, fluorine, chlorine, bromine, iodine, cyano, C₁- to C₅-alkyl, alkoxy, acyl, alkylsulfonyl, aryl, carboxyl or B(OH)₂,
c) that a curing accelerator is mixed with the epoxy resin to accelerate curing of the epoxy resin, wherein the curing accelerator comprises a compound of formula (III)

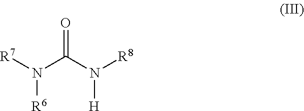

wherein R⁶, R⁷, R⁸ are independently of one another:
R⁶, R⁷=independently of one another hydrogen or C₁- to C₅ alkyl,
R⁸=hydrogen, C₁- to C₁₅-alkyl, C₃- to C₁₅-cycloalkyl, aryl, alkylaryl,
   C₁- to C₁₅-alkyl substituted with —NHC(O)NR⁶R⁷,
   C₃- to C₁₅-cycloalkyl substituted with —NHC(O)NR⁶R⁷,
   aryl substituted with —NHC(O)NR⁶R⁷ or
   alkylaryl substituted with —NHC(O)NR⁶R⁷,
d) that optionally a curing agent is mixed with the epoxy resin, the curing agent comprising cyanamide and/or a compound of formula (IV),

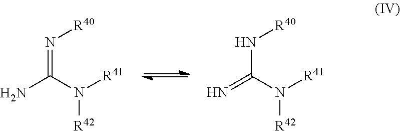

wherein residues R⁴⁰, R⁴¹, R⁴² are independently of one another:
   R⁴⁰=cyano, nitro, acyl or a residue of the formula
   (C═X)—R⁴³, wherein X=imino or oxygen,
   R⁴³=amino, alkylamino or alkoxy,
   R⁴¹=hydrogen, C₁- to C₅-alkyl, aryl or acyl,
   R⁴²=hydrogen or C₁- to C₅-alkyl,
e) that optionally a thickening agent is mixed with the heated epoxy resin from step a),
   wherein the temperature exposure of the epoxy resin according to step a) is at least 15 min and must not exceed 240 min, and
   wherein two or more of the method steps a) to e) can be carried out simultaneously and/or successively.

Since epoxy resin compositions which do not contain a curing agent from the group comprising cyanamide and the compounds of formula (IV) have also been found to be sufficiently reactive, methods in which method step d) is not present are also the subject of the present invention. In a preferred method variant, method step d) is included.

According to the present invention, epoxy resin composition means a composition whose epoxy resins are thermosetting, i.e. are polymerizable, linkable or cross-linkable by heat due to their functional groups, namely epoxy groups. Here, polymerization, linking or cross-linking occurs as a result of a polyaddition induced by the curing agent and the curing accelerator.

In the context of the present invention, alkyl is to be understood as a saturated, linear or branched aliphatic residue, in particular an alkyl residue having the general formula CₙH₂ₙ₊₁, wherein n represents the number of carbon atoms of the residue. Alkyl can mean a residue with a larger number of carbon atoms. Preferably, alkyl means a saturated, linear or branched aliphatic residue having the general formula CₙH₂ₙ₊₁, wherein n represents the number of carbon atoms of the residue and n represents a number from 1 to 15. Thus, alkyl preferably means C₁- to C₁₅-alkyl, even more preferably C₁-C₁₀-alkyl. It is further preferred that C₁- to C₁₅-alkyl means in particular methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 1,1-dimethylpropyl, 1,2-dimethylpropyl, 2,2-dimethylpropyl, 1-ethylpropyl, n-hexyl, n-heptyl, n-octyl, n-nonyl, n-decyl, n-undecyl or n-dodecyl.

Furthermore, C₁- to C₅-alkyl means a saturated, linear or branched alkyl residue having up to five carbon atoms. Preferably, C₁- to C₅-alkyl means in particular methyl, ethyl, n-propyl, 1-methylethyl, n-butyl, 1-methylpropyl, 2-methylpropyl, 1,1-dimethylethyl, n-pentyl, 1-methylbutyl, 2-methylbutyl, 3-methylbutyl, 1,1-dimethylpropyl, 1,2-dimethylpropyl, 2,2-dimethylpropyl or 1-ethylpropyl.

According to the present invention, hydroxyalkyl means an alkyl residue as defined above which is substituted with one, two or three hydroxy groups. According to the present invention, hydroxyalkyl means in particular an alkyl residue which has up to 15 carbon atoms and which is substituted by a hydroxy group. Thus, hydroxyalkyl preferably means C₁- to C₁₅-hydroxyalkyl. Further preferably, hydroxyalkenyl preferably means C₁- to C₅-hydroxyalkyl. Particularly preferably, hydroxyalkyl means hydroxymethyl, 2-hydroxyethyl, 3-hydroxypropyl, 4-hydroxybutyl or 5-hydroxypentyl.

In the context of the present invention, C₃- to C₁₅-cycloalkyl is further intended to mean a saturated, monocyclic or bicyclic aliphatic residue having 3 to 15 carbon atoms, in particular a cycloalkyl residue which has the general formula CₙH₂ₙ₋₁, wherein n=an integer from 3 to 15. In this context, it is preferably intended that C₃- to C₁₅-cycloalkyl means in particular cyclopropyl, cyclobutyl, cyclopentyl, cyclohexyl or cycloheptyl, it being possible for these cycloalkyl residues in turn to be further preferably mono- or polysubstituted by alkyl as defined above.

According to the present invention, C₃- to C₁₅-cycloalkyl particularly preferably means cyclopentyl, cyclohexyl, which in turn may be mono- or polysubstituted with alkyl, in particular 3,3,5,5-tetramethyl-1-cyclohexyl.

Cyano denotes a nitrile group of the general formula CN.

Nitro denotes a functional group of the general formula NO₂.

Amino denotes a functional group of the general formula NH₂.

Imino denotes a functional group of the general formula NH.

According to the present invention, alkylamino means a residue of the formula NHₙ(alkyl)₂₋ₙ, with n=0 or 1, wherein alkyl is an alkyl residue of the meaning given above and wherein the binding site is located at the nitrogen.

Carboxyl denotes a functional group of the general formula COOH.

According to the present invention, alkoxy means a residue of the formula O-alkyl, wherein alkyl is an alkyl residue of the meaning given above and wherein the binding site is located at the oxygen. According to the present invention, alkoxy means, in particular, an alkoxy residue whose alkyl residue has up to 15 carbon atoms, in particular up to 5 carbon atoms.

Thus, alkoxy preferably means C₁- to C₁₅-alkoxy and more preferably C₁- to C₅-alkoxy. Particularly preferably, alkoxy means methoxy, ethoxy, n-propoxy-, n-butoxy or n-pentoxy.

According to the present invention, acyl means a residue of the formula C(O)—R⁵, wherein R⁵ is bonded to the carbon and may be hydrogen, alkyl or alkoxy of the meaning given above and wherein the binding site of the acyl residue is located on the carbon. Particularly preferably, acyl means formyl or acetyl.

Further, alkylsulfonyl means a residue of the formula SO₂-alkyl, wherein both the binding site of the alkylsulfonyl residue and the alkyl residue are located on the sulfur, and wherein alkyl is an alkyl residue of the meaning given above. In accordance with the present invention, alkylsulfonyl more particularly means an alkylsulfonyl residue whose alkyl residue has up to 15 carbon atoms. Thus, alkylsulfonyl preferably means C₁- to C₁₅-alkylsulfonyl, and more preferably C₁- to C₅-alkylsulfonyl. Particularly preferably, alkylsulfonyl means methylsulfonyl, ethylsulfonyl, n-propylsulfonyl, n-butylsulfonyl or n-pentylsulfonyl.

According to the present invention, aryl means an aromatic residue, in particular an aromatic residue having 6 to 15 carbon atoms, which may be monocyclic, bicyclic or polycyclic. Thus, aryl preferably means C₆- to C₁₅-aryl. Particularly preferably, aryl means phenyl, naphthyl, anthryl, phenantryl, pyrenyl or perylenyl, most preferably phenyl.

Furthermore, according to the present invention, alkylaryl means an aromatic residue, of the type described above, which in turn is mono- or polysubstituted with alkyl of the type described above. In particular, alkylaryl means an aromatic residue having 6 to 15 carbon atoms. Thus, aryl preferably means C₆- to C₁₅-alkylaryl. Furthermore, alkylaryl preferably means methylphenyl, dimethylphenyl or trimethylphenyl.

Surprisingly, it has been shown that by adding substituted boronic acids according to formula (I) of the invention to epoxy resin compositions containing an epoxy resin, a curing accelerator and optionally a curing agent, the loss of properties and quality of the epoxy resin compositions when exposed to temperature in the manufacturing method of the epoxy resin compositions is minimized. Surprisingly, it has been shown that when the substituted boronic acid of the invention is used, the curing properties and reactivity of the epoxy resin composition are retained even after heating to a temperature in the range of 60° C. to 100° C. This means that there is no reduction in the quality of the curing properties in the desired prepregs and towpregs. In addition, it has been shown that the viscosity of the epoxy resin itself is not significantly affected after temperature treatment. Thus, the desired viscosity can be adjusted by the addition of a thickener alone, if this is necessary. Thus, the desired impregnating properties of the epoxy resin composition are maintained. The addition of substituted boronic acids does not affect the glass transition temperature to be achieved. Thus, the overall curing properties of the curing agents and curing accelerators, which are achieved without the addition of the substituted boronic acids, are not changed and are substantially maintained. Overall, therefore, an epoxy resin composition can be provided which can be methoded at temperature exposures of 60° C. to 100° C. for several hours without affecting the curing properties and which is thus eminently suitable for use in prepregs or towpregs.

According to the invention, substituted boronic acids of formula (I) can be used, wherein R¹ in formula (I) can mean alkyl, hydroxyalkyl or a residue of formula (II). Preferably, R¹ in formula (I) can mean alkyl or hydroxyalkyl, and it can further preferably be provided that R¹ has the following meaning:
R¹=methyl, ethyl, n-propyl, 1-methylethyl, n-butyl, 1-methylpropyl, 2-metylpropyl, n-pentyl, n-hexyl, n-heptyl, n-octyl, n-nonyl, n-decanyl, hydroxymethyl, 2-hydroxyethyl, 3-hydroxypropyl, 4-hydroxybutyl, or 5-hydroxypentyl.

In accordance with the present invention, R¹ can also be a residue of formula (II) wherein at least one substituent R², R³, R⁴ is not hydrogen. Thus, alternatively and preferably, R¹ in formula (I) can mean a residue of formula (II), wherein residues R², R³, R⁴ in formula (II) are:
R²=fluorine, chlorine, bromine, iodine, cyano, C₁- to C₅-alkyl, alkoxy, acyl, alkylsulfonyl, aryl, carboxyl or B(OH)₂,
R³, R⁴=hydrogen.

Further preferably, R¹ in formula (I) may be a residue of formula (II), wherein R², R³, R⁴ in formula (II) are:
R² fluorine, cyano, acyl, alkylsulfonyl, or B(OH)₂,
R³, R⁴=hydrogen.

Still further preferably, R¹ in formula (I) may be a residue of formula (II), wherein R², R³, R⁴ in formula (II) are:
R²=fluorine, cyano, formyl, acetyl, methylsulfonyl, ethylsulfonyl, n-propylsulfonyl, n-butylsulfonyl, n-pentylsulfonyl, or B(OH)₂,
R³, R⁴=hydrogen.

According to a further alternative, R¹ in formula (I) can preferably also mean a residue of formula (II), wherein R², R³, R⁴ in formula (II) are:
R², R³=independently fluorine, chlorine, bromine, iodine, cyano, C₁- to C₅-alkyl, alkoxy, acyl, alkylsulfonyl, aryl, carboxyl or B(OH)₂,
R⁴=hydrogen.

Further preferably, R¹ in formula (I) may be a residue of formula (II), wherein R², R³, R⁴ in formula (II) are:
R², R³=independently fluorine or alkoxy,
R⁴=hydrogen.

Still further preferably, R¹ in formula (I) may be a residue of formula (II), wherein R², R³, R⁴ in formula (II) are:
R², R³=independently fluorine, methoxy, ethoxy, n-propoxy, n-butoxy or -n-pentoxy,
R⁴=hydrogen.

According to a further alternative, R¹ in formula (I) can preferably also be a residue of formula (II), wherein residues R², R³, R⁴ in formula (II) independently of one another are:
R², R³, R⁴=fluorine, chlorine, bromine, iodine, cyano, C₁- to C₅-alkyl, alkoxy, acyl, alkylsulfonyl, aryl, carboxyl or B(OH)₂.

Further preferably, R¹ in formula (I) may be a residue of formula (II), wherein R², R³, R⁴ in formula (II) independently of one another are:
R², R³, R⁴=fluorine or C₁- to C₅-alkyl.

Still further preferably, R¹ in formula (I) may be a residue of formula (II), residues R², R³, R⁴ in formula (II) independently of one another are:
R², R³, R⁴=fluorine, methyl, ethyl, n-propyl, 1-methylethyl, n-butyl, 1-methylpropyl, 2-methylpropyl, 1,1-dimethylethyl, n-pentyl.

Particularly preferably, formula (I) denotes a substance selected from the group 4-formylphenylboronic acid, 1,4-benzenediboronic acid, 3-fluorophenylboronic acid, 2,4-difluorophenylboronic acid, 2,5-dimethoxyphenylboronic acid, methylboronic acid, 4-ethylphenylboronic acid, 1-octylboronic acid, 2-carboxyphenylboronic acid, 3-carboxyphenylboronic acid, 4-carboxyphenylboronic acid, (2-hydroxymethyl)phenylboronic acid, 4-cyanophenylboronic acid, 4-(methanesulfonyl)phenylboronic acid, 3,4,5-trifluorophenylboronic acid or mixtures thereof.

Surprisingly, it has been shown that such epoxy resin compositions are particularly temperature-stable in the range above 60° C., so that the homogeneous mixing of the epoxy resin with additives or the incorporation of thickeners is facilitated or made possible in the first place. Thus, it has been shown that epoxy resin compositions containing a polymerization retarder of formula (I), a curing accelerator of formula (III) and, optionally, a curing agent of formula (IV) or cyanamide have a low tendency to react at temperatures above 60° C. up to 100° C., preferably between 65° C. and 90° C., in particular between 70° C. and 85° C., for up to 4 h.

The temperature exposure of the epoxy resin for mixing in the individual additives should be in the range of 15 min to 4 h, preferably between 30 min and 3 h and in particular between 45 min and 2 h. If a higher temperature is set, shorter times are preferred to avoid polymerization to a considerable extent in the epoxy resin composition. Therefore, a temperature exposure of 30 min to 90 min at a temperature of 70° C. to 90° C. and, in particular, a temperature exposure between 30 min and 90 min at a temperature between 70° C. and 90° C. is particularly preferred.

Surprisingly, it has been shown that the other curing properties, such as reactivity or viscosity, of the epoxy resin composition obtained according to the invention after heating to 60° C. to 100° C. are comparable to the curing and rheological properties of non-tempered compositions. In addition, the rheological properties can be easily adjusted by means of the described method, for example by using thickeners. Thus, the epoxy resin compositions obtained by the described method can be excellently used for the pre-impregnation of materials and, in particular, for the production of prepregs or towpregs.

In accordance with the present invention, curing agents selected from the group consisting of cyanamide or guanidines, in particular cyanoguanidines, nitroguanidines, acylguanidines or biguanidines, can be used or employed as curing agents for curing the epoxy resins in optional method step d). Preferably, cyanamide or a curing agent according to general formula (IV) can be used as curing agent, wherein the formula (IV) is as follows

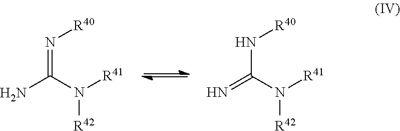

wherein residues R⁴⁰, R⁴¹, R⁴² independently of one another are:
R⁴⁰=cyano, nitro, acyl or a residue of the formula —(C═X)—R⁴³, wherein
X=imino or oxygen,
R⁴³=amino, alkylamino or alkoxy,
R⁴¹=hydrogen, C₁- to C₅-alkyl, aryl, benzyl, or acyl,
R⁴²=hydrogen or C₁- to C₅-alkyl.

In this context, those curing agents according to formula (IV) are further preferred for which R⁴¹=hydrogen or C₁- to C₅-alkyl and/or R⁴²=hydrogen or C₁- to C₅-alkyl, and C₁- to C₅-alkyl simultaneously or independently of one another represents the residues methyl, ethyl, n-propyl, isopropyl, n-butyl or n-pentyl.

Particularly preferably, curing agents of formula (IV) can be used, for which the following applies:
R⁴⁰=cyano or nitro, in particular cyano,
R⁴¹=hydrogen, methyl or ethyl, in particular hydrogen,
R 42=hydrogen, methyl or ethyl, in particular hydrogen.

As curing agents for curing the epoxy resins of the general formula (IV), preferably applied are cyanoguanidine, 1,1-dimethyl-3-cyanguanidine, 1-acetyl-3-cyanguanidine, 1-(p-chlorophenyl)-3-cyanguanidine, nitroguanidine, 1-methyl-3-nitroguanidine, 1-ethyl-3-nitroguanidine, 1-butyl-3-nitroguanidine, 1-benzyl-3-nitroguanidine, formylguanidine, acetylguanidine, carbamoylguanidine or methoxycarbonylguanidine, particularly preferably cyanoguanidine. These cyanoguanidine derivatives or nitroguanidine derivatives are characterized by a particularly high latency.

As an alternative to a compound of formula (IV) or together with a compound of formula (IV), cyanamide can also be used as a curing agent for curing the epoxy resins.

According to the present invention, urea derivatives, in particular urea derivatives according to formula (III), can be used or employed as curing accelerators, wherein formula (III) is as follows:

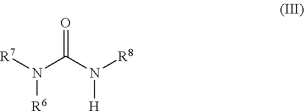

wherein R⁶, R⁷, R⁸ independently of one another are:
R⁶, R⁷=independently of one another hydrogen or C₁- to C₅-alkyl,
R⁸=hydrogen, C₁- to C₁₅-alkyl, C₃- to C₁₅-cycloalkyl, aryl, alkylaryl,
   C₁- to C₁₅-alkyl substituted with —NHC(O)NR⁶R⁷,
   C₃- to C₁₅-cycloalkyl substituted with —NHC(O)NR⁶R⁷,
   aryl substituted with —NHC(O)NR⁶R⁷ or
   alkylaryl substituted with —NHC(O)NR⁶R⁷.

Of the urea derivatives of formula (III) described, the use of aromatic urea derivatives is preferred. Further preferred here are aromatic urea derivatives of formula (III), wherein residues R⁶, R⁷, R⁸ independently are:
R⁶, R⁷=independently of one another C₁- to C₅-alkyl, in particular methyl or ethyl,
R⁸ aryl, arylalkyl, or
   aryl substituted with —NHC(O)NR⁶R⁷ or
   alkylaryl substituted with —NHC(O)NR⁶R⁷.

Further preferably, residues R⁶, R⁷, R⁸ may be independent of each other:
R⁶, R⁷=independently of one another C₁- to C₅-alkyl, in particular methyl or ethyl,
R⁸ aryl substituted with —NHC(O)NR⁶R⁷ or
   alkylaryl substituted with —NHC(O)NR⁶R⁷, in particular
   alkylaryl substituted with —NHC(O)NR⁶R⁷.

Thus, according to the present invention, urea derivatives are particularly preferred in which formula (III) has the preferred formula (V), wherein formula (V) is:

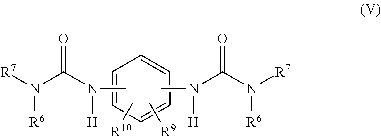

and wherein residues R⁶, R⁷, R⁹, R¹⁰ independently of one another are:
R⁶, R⁷=independently of one another hydrogen or C₁- to C₅-alkyl, in particular hydrogen, methyl or ethyl,
R⁹, R¹⁰=independently of one another hydrogen or C₁- to C₅-alkyl, in particular hydrogen, methyl or ethyl.

Preferably, residues R⁶, R⁷, R⁹ in connection with formula (V) each denote a methyl residue and R¹⁰ denotes hydrogen. Particularly preferred is 1,1′-(4-methyl-m-phenylene)bis(3,3-dimethylurea) and 1,1′-(2-methyl-m-phenylene)bis(3,3-dimethylurea).

Of the urea derivatives of formula (III) described, aliphatic urea derivatives can furthermore preferably be used. Aliphatic urea derivatives of formula (III) are further preferred here, wherein residues R⁶, R⁷, R⁸ independently are:
R⁶, R⁷=independently of one another hydrogen or C₁- to C₅-alkyl, in particular hydrogen, methyl or ethyl,
R⁸=hydrogen or C₁- to C₁₅-alkyl, C₃- to C₁₅-cycloalkyl,
   C₁- to C₁₅-alkyl substituted with —NHC(O)NR⁵R⁶,
   C₃- to C₁₅-cycloalkyl substituted with —NHC(O)NR⁵R⁶

Further preferred are aliphatic urea derivatives according to formula (III), in which R⁶ and R⁷ are as defined above, in particular hydrogen, methyl or ethyl, and R⁸ denotes hydrogen or C₁- to C₁₅-alkyl, in particular methyl, ethyl, n-propyl, 1-methylethyl, n-butyl, 1-methylpropyl, 2-metylpropyl, n-pentyl, n-hexyl, n-heptyl, n-octyl, n-nonyl or n-decanyl. Particularly preferably, residues R⁶, R⁷ in formula (III) each denote methyl and R⁸ denotes n-butyl. N-(n-butyl-)-N′,N′-dimethylurea is particularly preferred.

Further preferred are aliphatic urea derivatives according to formula (III), in which R⁶ and R⁷ are as defined above, in particular hydrogen, methyl or ethyl, and R³ is C₁- to C₁₅-cycloalkyl substituted with —NHC(O)NR¹R².

Thus, according to the present invention, urea derivatives are particularly preferred in which formula (III) has the preferred formula (VI), wherein formula (VI) is

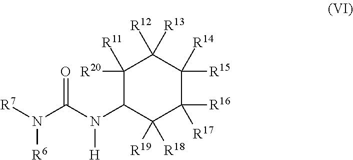

wherein the residues simultaneously or independently of each other are:
R⁶, R⁷=independently of one another hydrogen or C₁- to C₅-alkyl, in particular hydrogen, methyl or ethyl;
R¹¹, R¹², R¹³, R¹⁴, R¹⁵, R¹⁶, R¹⁷, R¹⁸, R¹⁹, R²⁰=independently of one another hydrogen, C₁- to C₅-alkyl or C₁- to C₅-alkyl substituted with —NHC(O)NR⁶R⁷.

Further preferred are curing accelerators comprising aliphatic urea derivatives of formula (VI) wherein R⁶ and R⁷ are simultaneously or independently of one another hydrogen, methyl or ethyl and R¹¹, R¹², R¹³, R¹⁴, R¹⁵, R¹⁶, R¹⁷, R¹⁸, R¹⁹, R²⁰ independently of one another are hydrogen, methyl, ethyl, —NHC(O)NR⁶R⁷ or methyl or ethyl substituted with —NHC(O)NR⁶R⁷. Particularly preferred is 1-(N,N-dimethylurea)-3-(N,N-dimethylurea-methyl)-3,5,5-trimethylcyclohexane, hereinafter also N′-[3-[[[(dimethylamino) carbonyl]-amino]methyl]-3,5,5-trimethylcyclohexyl]-N, N-dimethylurea (i.e. R⁶=R⁷=R¹²=R¹³=R¹⁶-methyl and R¹⁷=—CH₂—NHC(O)N(CH₃)₂ and R¹¹=R¹⁴=R¹⁵=R¹⁸=R¹⁹=R²⁰=hydrogen).

The method described herein preferably yields an epoxy resin composition whose polymerization behavior remains as unchanged as possible after temperature exposure. The epoxy resin compositions obtained by this method are preferably characterized, after a temperature exposure of 80° C. for one hour, by having an onset temperature and/or a peak temperature which is at least 5% to at most 20% higher than that of a corresponding epoxy resin without polymerization retarder, the onset temperature and the peak temperature being determined by dynamic DSC measurement at a temperature of −30° C. to 250° C. with a heating rate of 10° C./min.

Particularly preferably, the epoxy resin composition obtained after a temperature exposure of 80° C. for one hour is characterized in that the onset temperature deviates by at most 3.5% from the onset temperature of the corresponding epoxy resin composition without temperature exposure and/or after a temperature exposure of 80° C. for one hour the peak temperature deviates by at most 3% from the peak temperature of the corresponding epoxy resin composition without temperature exposure, the onset temperature and the peak temperature being determined by dynamic DSC measurement at a temperature of −30° C. to 250° C. with a heating rate of 10° C./min.

Conversely, in the method described herein, the temperature exposure can be selected so that the onset or peak temperatures just mentioned are reached in the dynamic DSC measurement, wherein the duration of the heating and the set temperature must be within the ranges defined for method step a).

In principle, method steps a), b) c), d) and e) can be carried out in any order. Preferably, method steps a), b) c), d) and e) and, in particular, the addition of the polymerization retarder, the curing accelerator, the optional curing agent and the optional thickener are carried out successively or simultaneously.

In order to achieve the preferred onset and peak temperatures in the epoxy resin compositions obtained, the selection of a particular method step sequence may also be appropriate. For example, it may be useful to add at least a portion of the polymerization retarder to the polymer resin before the curing accelerator and, in particular, before the curing agent. This is particularly advantageous if the at least partial addition of the polymerization retarder takes place after the epoxy resin has been heated. Thus, in a preferred embodiment of the method described herein, at least 50 wt. % of the polymerization retarder is added before or together with the curing accelerator, optionally the curing agent and the thickener.

Furthermore, it is advantageous if the total amount of thickener is not added to the epoxy resin before mixing in the other additives, so that the viscosity of the mixture remains low until all additives have been incorporated. Thus, in a preferred embodiment of the method described herein, at least 50 wt. % of the thickener is added after or together with the polymerization retarder, the curing accelerator and, if necessary, the curing agent.

In a further preferred embodiment, at least two, preferably three or all method steps b) to e) are carried out simultaneously, wherein the necessary temperature exposure and the method effort can be reduced. For example, the individual additives can be introduced before heating, with homogeneous mixing with the epoxy resin taking place later during heating (method step a)). Alternatively, the additives, i.e. the polymerization retarder, the curing accelerator, the curing agent and the thickener, can also be mixed with the epoxy resin after or during heating.

According to the present invention, rheology modifiers such as thermoplastic polymers in particular can be introduced into the epoxy resin composition as thickeners. The thickener has the function of adapting the flow behavior of the resin so that flow of the resin out of the prepreg is counteracted. In addition, the thickener also contributes to the mechanical properties of the cured epoxy resin. Typically, thermoplastic additives from the group of phenoxy resins, acrylate, acrylonitrile, polyetherimide, polyetherketone or polysulfone polymers are chosen. Due to their positive influence on the flow behavior during processing and the mechanical properties of the cured component, phenoxy resins, polyacrylates or polysulfones are preferably used. In addition, powdery, inorganic thickeners can also be added, such as fumed silica, among others. These can be added to the epoxy resin composition individually or mixed from two or more, or mixed with one, two or more thermoplastic polymers.

By the method described, the viscosity of the epoxy resin composition obtained can be adjusted to allow impregnation of the material (e.g. fibers) during prepreg or towpreg production. Preferably, the viscosity of the epoxy resin composition is adjusted to be in a range of 10 to 1000 Pa*s, and the temperature for determining the viscosity must be greater than or equal to 50° C. and less than or equal to 80° C. To determine the viscosity, a rheometer according to Anton Paar viscometer MCR302 with measuring system D-PP25 (1° measuring cone) at a measuring gap of 0.052 mm is used. Here, a dynamic run from 50° C. to 80° C. is performed at a rate of 5° C./min. The preferred epoxy resin compositions are present when the viscosity range just mentioned is hit during the dynamic measurement run.

In the context of the present invention, the term epoxy resin is understood to mean the epoxy monomer composition. Epoxy resins which are liquid at below 100° C., in particular at below 90° C., are particularly suitable for preparing the epoxy resin compositions. Preferably, the epoxy resin is a polyether having at least one, preferably at least two epoxy groups and still further preferably having at least three epoxy resin groups. These epoxy resins or liquid epoxy resins may have at least one, preferably at least two epoxy groups and may be saturated or unsaturated, aliphatic, cycloaliphatic, aromatic or heterocyclic. Furthermore, these epoxy resins or liquid epoxy resins, may have substituents such as halogens, phosphorus and hydroxyl groups. Bisphenol-based epoxy resins, in particular bisphenol A diglycidyl ether as well as the bromine-substituted derivative (tetrabromobisphenol A) or bisphenol F diglycidyl ether, novolak epoxy resins, in particular epoxyphenol novolak or aliphatic epoxy resins are preferably used here. Epoxy resins based on glycidyl polyethers of 2,2bis-(4-hydroxyphenyl) propane (bisphenol A) and the bromine-substituted derivative (tetrabromobisphenol A), glycidyl polyethers of 2,2bis-(4-hydroxyphenyl) methane (bisphenol F) and glycidyl polyethers of novolaks as well as those based on aniline or substituted anilines such as p-aminophenol or 4,4′-diaminodiphenylmethanes are particularly preferred. Epoxy resins based on glycidyl polyethers of 2,2-bis(4-hydroxyphenyl) propane (bisphenol A) and epoxy resins based on glycidyl polyethers of 2,2-bis(-4-hydroxyphenyl) methane (bisphenol F) are particularly preferred.

Further preferred epoxy resins, in particular liquid epoxy resins, can be used according to the present invention which have an EEW value (epoxy equivalent weight) in the range of EEW=100 to 1500 g/eq, in particular in the range of EEW=100 to 1000 g/eq, in particular in the range of EEW=100 to 600 g/eq, further preferred in the range of EEW=100 to 400 g/eq and very particularly preferred in the range of EEW=100 to 300 g/eq.

For use in prepregs or towpregs, low-cost liquid epoxy resins are particularly preferred, which have a viscosity range of 2 to 30 Pats, preferably 8 to 20 Pats at 25° C., and which require a thickener to increase the viscosity. The preferred resin EPIKOTE™ Resin 828 with a viscosity of 12-14 Pas at 25° C. serves as an example. The viscosity of the epoxy resin compound is usually specified by the suppliers. Alternatively, the viscosity can also be determined with a rheometer according to Anton Paar viscometer MCR302 with measuring system D-PP25 (1° measuring cone) at a measuring gap of 0.052 mm. Here, the isothermal viscosity is measured at 25° C. by means of continuous recording of 1 or 0.5 measuring points per min.

Particularly preferred are epoxy resins which, after a temperature exposure of 80° C. for 1 h, have an onset temperature of between 11° and 150° C. and/or a peak temperature of between 120° C. and 160° C., the onset temperature and the peak temperature being determined by dynamic DSC measurement at a temperature of −30° C. to 250° C. at a heating rate of 10° C./min, the epoxy resins already containing the curing accelerator and optionally the curing agent but not the polymerization retarder and thickener during the dynamic DSC measurement.

The curing profile of the formulations according to the invention can be varied by adding further, commercially available additives, such as those known to those skilled in the art for curing epoxy resins.

Reactive thinners and thermoplastic additives are commonly used in prepreg, towpreg, and adhesive formulations.

Thus, further additives can be added to the epoxy resin as part of the claimed method, such as reactive diluents and/or thermoplastic polymers.

Glycidyl ethers in particular can be used as reactive diluents in the method according to the invention. Monofunctional, difunctional and polyfunctional glycidyl ethers can also preferably be used. In particular, glycidyl ethers, diglycidyl ethers, triglycidyl ethers, polyglycidyl ethers and multiglycidyl ethers and combinations thereof should be mentioned here. Particularly preferred glycidyl ethers may be selected from the group comprising 1,4-butanediol diglycidyl ether, trimethylolpropane triglycidyl ether, 1,6-hexanediol diglycidyl ether, cyclohexanedimethanol diglycidyl ether, C₈-C₁₀-alcohol glycidyl ether, C₁₂-C₁₄-alcohol glycidyl ether, cresol glycidyl ether, poly(tetramethylene oxide) diglycidyl ether, 2-ethylhexyl glycidyl ether, polyoxypropylene glycol diglycidyl ether, polyoxypropylene glycol triglycidyl ether, neopentyl glycol diglycidyl ether, p-tert-butylphenol glycidyl ether, polyglycerol multiglycidyl ether, and combinations thereof.

Very particularly preferred glycidyl ethers are 1,4-butanediol diglycidyl ethers, trimethylolpropane triglycidyl ethers, neopentyl glycol diglycidyl ethers, 1,6-hexanediol diglycidyl ethers, cyclohexanedimethanol diglycidyl ethers, and combinations thereof.

Additives for improving the processability of uncured epoxy resin compositions or for adapting the thermo-mechanical properties of thermoset products to the requirement profile include, for example, fillers, rheological additives such as thixotropic agents or dispersing additives, defoamers, dyes, pigments, toughening modifiers, impact modifiers, nanofillers, nanofibers, or fire protection additives.

The amounts of substituted boronic acids to be used as well as the curing agents and curing accelerators in the epoxy resin compositions can be adjusted according to the present invention with respect to the amount of epoxy resins to be used. Preferably, based on 100 parts by weight of epoxy resin, in particular 0.05 to 3.0 parts by weight of substituted boronic acid according to formula (I), further preferably 0.1 to 2.0 parts by weight of substituted boronic acid according to formula (I) and particularly preferably 0.1 to 1.0 parts by weight of substituted boronic acid according to formula (I) can be used.

Furthermore, in the method described, based on 100 parts by weight of epoxy resin, in particular 1.0 to 15 parts by weight of curing agent, in particular from the group cyanamide or the group of curing agents according to formula (IV), further preferably 3.0 to 12.0 parts by weight of curing agent, in particular from the group cyanamide or the group of curing agents according to formula (IV), and particularly preferably 4.0 to 10.0 parts by weight, in particular from the group cyanamide or the group of curing agents according to formula (IV), can be used.

According to the method described, preferably, based on 100 parts by weight of epoxy resin, 0.1 to 9 parts by weight of curing accelerator, in particular from the group of curing accelerators according to formula (III), further preferably 0.5 to 5.0 parts by weight of curing accelerator, in particular from the group of curing accelerators according to formula (III), and particularly preferably 0.5 to 3.0 parts by weight of curing accelerator, in particular from the group of curing accelerators according to formula (III), can be used.

Preferably, the curing agents and the substituted boronic acid are used in the preparation of the epoxy resin composition in a weight ratio of curing agents to substituted boronic acid in the range from 1:1 to 240:1, more preferably from 3:1 to 100:1 and particularly preferably from 6:1 to 40:1.

Further preferred in the method described herein are curing accelerators and the substituted boronic acid in a weight ratio of curing accelerator to substituted boronic acid in the range from 0.05:1 to 160:1, more preferably from 0.5:1 to 50:1 and particularly preferably from 0.7:1 to 15:1.

The epoxy resin compositions produced by the method described are particularly suitable for the production of pre-impregnated materials, especially prepregs and towpregs made of fiber composites for the manufacture of fiber composite parts as used in the sports and leisure market, the automotive market, the aerospace industry and for the manufacture of rotor blades for wind turbines. All types of fibers known to those skilled in the art can be used for these fiber composites. Examples of these, without being limited to them, are chemical fibers from the group of inorganic materials such as carbon fibers, boron fibers, basalt fibers, glass fibers, quartz fibers, slag fibers, metal fibers, nanotube fibers, ceramic fibers, crystal fibers, or chemical fibers from the group of synthetic polymeric materials such as polyester, polyamide, polyimide, aramide, poyamidimide, polyacryl, modacryl, polytetrafluoroethylene, polyethylene, polyetheretherketone, polypropylene, polychloride, elastane, polybenzimidazole, polyurea, melamine, polyphenylene sulfide, polyvinyl alcohol, vinalone, polycarbonate, polystyrene, both as fibers with homopolymeric structures and as fibers of copolymeric structures such as e.g. random copolymers, gradient copolymers, block copolymers, alternating copolymers, graft copolymers, or chemical fibers from the group of natural polymeric substances such as e.g. cellulose, cellulose ester, polyactide, alginate, chitin, elastodiene, bio-based polyamides, protein fibers, or natural fibers from the group of vegetable fibers such as seed fibers from, among others, kapok, cotton, poplar fluff, wool grass, cattail, silk plants, such as bast fibers from, among others, bamboo, nettles, hemp, jute, mallow, broom, hops, willow bast, flax, ramie, kenaf, sunns, castor, punga, such as leaf fibers from agave, bromeliad, hemp, flax, sugar palm, dwarf palm, yucca, cattail, alfagrass, among others, such as fruit fibers from coconut, among others, furthermore natural fibers from the group of animal fibers such as fibers from spinning glands, including silk, spider silk, anaphe silk, erise silk, muga silk, tussah silk, such as fibers from secretions, including byssus silk, such as fibers from hair follicles, including hair and wool from sheep, alpacas, llamas, vicuñas, guanacos, camels, angora rabbits, cashmere goats, mohair goats, yaks, goats, cattle, horses, furthermore, mineral fibers such as glass fibers, quartz fibers, mineral wool, silica fibers, ceramic fibers, furthermore, the transformation products of named fibers such as e.g. nitrate silk, copper rayon, as well as the combinations of all named fibers. Preferred fibers are selected from the group of glass, carbon, aramid, basalt, rock wool, polyethylene, flax, hemp and bamboo fibers, as well as combinations thereof.

These fiber composites can be processed in processing methods such as, for example, autoclave, “out-of-autoclave”, vacuum bag and compression molding.

### EXAMPLES

### Materials Used:

Product name: EPIKOTE™ Resin 828 (Hexion Inc.)
Unmodified bisphenol A epoxy resin (EEW=184-190 g/eq)
(viscosity at 25° C.=12-14 Pa*s)
Product name: D.E.R.™ 337 (Blue Cube Germany Assets GmbH & Co. KG)
Modified semi-solid bisphenol A epoxy resin (EEW=230-250 g/eq)
(viscosity at 25° C.=400-800 mPa*s, 70 wt. % in diethylene glycol monobutyl ether)
Product name: D.E.R.™ 671 (Blue Cube Germany Assets GmbH & Co. KG)
Solid epoxy resin (EEW=475-550 g/eq)
(melting point=75-85° C.)
Resin 1: EP EPIKOTE™ Resin 828+D.E.R.™ 671 (80 wt. %+20 wt. %)
D.E.R.™ 671 dissolved for 2 h at 110° C. in EP EPIKOTE™ Resin 828
Product name: DYHARD® 100S (Alzchem Trostberg GmbH)
Latent curing agents, dicyandiamide, solid (particle size 98%≤10 μm)
Urea 1:1,1′-(4-methyl-m-phenylene)-bis-(3,3-dimethylurea) (Alzchem Trostberg GmbH)
Latent, bifunctional accelerator according to formula V
Solid (particle size 98%≤10 μm)
Product name: 3-fluorophenylboronic acid; (abcr GmbH)
Solid, (melting point=220° C.)
Product name: Octylboronic acid; (Alfa Aesar)
Solid (purity=97%; melting point=81-85° C.)
Product name: 1,4-benzenediboronic acid (Alfa Aesar)
Solid (purity=96%; melting point >300° C.)

### Preparation of the Mixtures:

For the examinations of the formulations mentioned in the examples, the individual components of the respective formulation are mixed in a dissolver for several minutes until homogeneity is achieved. The respective formulation is then divided into three portions. One portion is prepared without temperature exposure for prepreg production and the subsequent measurements. One formulation is prepared for prepreg production after mixing with a temperature exposure for 3 hours at 60° C. and then prepared for measurement. One formulation is prepared for prepreg production after mixing at a temperature of 80° C. for one hour and then prepared for measurement.

### Methods Used to Characterize the Compositions

### DSC Examinations:

DSC measurements are performed on a dynamic heat flow difference calorimeter DSC 1 or

DSC 3 (Mettler Toledo).

### a) Dynamic DSC:

A sample of the formulation is subjected to a dynamic DSC measurement from −30° C. to 250° C. with a heating rate of 10° C./min. The evaluation includes the enthalpy of the curing reaction, the onset temperature and the maximum peak.

### b) Isothermal DSC:

A sample of the formulation is kept constant at the specified temperature for the specified time (isothermal curing of the formulation). The evaluation is performed by determining the time of the 90% conversion (as a measure of the end of the curing process) of the exothermic reaction peak. Furthermore, the onset and peak temperatures are evaluated.

### Listing of Results:

TABLE 1
Reactivity of epoxy resin compositions in comparison

| Formulations | Ref. 1 | A | B | C | D | E | F |
|---|---|---|---|---|---|---|---|
| EPIKOTE ™ Resin 828 | 100 | 100 | 100 | 100 | 100 | 100 | 100 |
| DYHARD ® 100S | 6.5 | 6.5 | 6.5 | 6.5 | 6.5 | 6.5 | 6.5 |
| Urea 1 | 1.0 | 1.0 | 1.0 | 1.0 | 1.0 | 1.0 | 1.0 |
| 1-octylboronic acid | | 0.2 | 0.4 | | | | |
| 3-Fluorophenylboronic acid | | | | 0.2 | 0.4 | | |
| 1,4-Benzendiboronic acid | | | | | | 0.2 | 0.4 |

Without temperature exposure

| | | | | | | | |
|---|---|---|---|---|---|---|---|
| Dynamic DSC | | | | | | | |
| Onset Temp [° C.] | 144 | 148 | 149 | 149 | 153 | 150 | 153 |
| Peak Temp [° C.] | 152 | 156 | 159 | 156 | 160 | 158 | 162 |
| Isothermal DSC; 2 h at 120° C. | | | | | | | |
| Time to 90% turnover [min] | 41 | 46 | 53 | 46 | 54 | 48 | 58 |
| Isothermal DSC; 1 hr at 140° C. | | | | | | | |
| Time to 90% turnover [min] | 17 | 18 | 20 | 19 | 21 | 19 | 21 |

Temperature exposure 3 h @ 60° C.

| | | | | | | | |
|---|---|---|---|---|---|---|---|
| Dynamic DSC | | | | | | | |
| Onset Temp [° C.] | 140 | 148 | 151 | 150 | 154 | 150 | 155 |
| Peak Temp [° C.] | 149 | 155 | 158 | 157 | 161 | 158 | 162 |
| Isothermal DSC; 2 h at 120° C. | | | | | | | |
| Time to 90% turnover [min] | 33 | 42 | 52 | 47 | 55 | 45 | 59 |
| Isothermal DSC; 1 hr at 140° C. | | | | | | | |
| Time to 90% turnover [min] | 15 | 18 | 20 | 19 | 21 | 18 | 22 |

Temperature exposure 1 h @ 80° C.

| | | | | | | | |
|---|---|---|---|---|---|---|---|
| Dynamic DSC | | | | | | | |
| Onset Temp [° C.] | 135 | 147 | 150 | 149 | 155 | 150 | 155 |
| Peak Temp [° C.] | 146 | 154 | 157 | 157 | 162 | 157 | 162 |
| Isothermal DSC; 2 h at 120° C. | | | | | | | |
| Time to 90% turnover [min] | 31 | 41 | 48 | 45 | 58 | 46 | 63 |
| Isothermal DSC; 1 hr at 140° C. | | | | | | | |
| Time to 90% turnover [min] | 14 | 18 | 19 | 18 | 22 | 19 | 22 |

Description and Evaluation of the Results from Table 1:

Examples A to F and reference example Ref. 1 describe epoxy resin compositions consisting of curing agent and curing accelerator in a commercially available epoxy resin with or without substituted boronic acids. Examples A to F as well as Ref. 1 were subjected to temperature exposures typical for prepreg and towpreg production. Subsequently, analyses were carried out by means of dynamic DSC and isothermal DSC.

After temperature exposure for 3 h at 60° C., the epoxy resin compositions are characterized by dynamic DSC. Ref. 1 shows an onset temperature decrease of 3% (4° C.) and a peak temperature shift of 2% (3° C.) to lower temperature after temperature exposure. Isothermal DSC analysis at 140° C. for 1 h shows that the time at 90% conversion decreases by 12% (2 min) at Ref. 1 after prior temperature exposure. At isothermal temperature for 2 h at 120° C., the time even decreases by 20% (8 min). Thus, the DSC measurements show that the obtained epoxy resin composition Ref. 1 reacts during temperature exposure, which leads to a decrease of onset and peak temperature as well as to a reduction of the conversion time.

By using a substituted boronic acid in examples A to F, there is no onset or peak temperature decrease in the dynamic DSC analysis after temperature exposure. In the isothermal DSC analysis at 140° C. for 1 h, there is no reduction in the turnover time. At a temperature exposure for 2 h at 120° C., a small reduction in the turnover time can be observed in examples A and E, which can be attributed to the lower amount of boronic acid. In these examples, the value is nevertheless significantly lower than the conversion time of the comparative example Ref.1. Thus, a higher proportion of the substituted boronic acids according to the invention causes a lower influence on the epoxy resin formulation due to the previous temperature exposure.

Temperature exposure for 1 h at 80° C. results in an onset temperature decrease of 6% (9° C.) and a peak temperature shift of 4% (6° C.) to lower temperatures in comparative example Ref. 1. Isothermal DSC analysis at 140° C. for 1 h shows that Ref. 1 experiences a decrease in turnover time of 18% (3 min) after prior temperature exposure. At a temperature exposure for 2 h at 120° C., this value decreases by 24% (10 min).

By using substituted boronic acid according to example A to F, there is no onset or peak temperature decrease in the dynamic DSC analysis after temperature exposure. In the isothermal DSC analysis at 140° C. for 1 h, there is no significant reduction in the turnover time. At 2 h at 120° C., a smaller reduction in the turnover time is observed in isolated cases, which remain below that of Ref. 1. By using a higher amount of substituted boronic acid, the influence of the previous temperature exposure on the epoxy resin formulation is reduced.

In summary, when the substituted boronic acids of examples A to F according to the invention are used, polymerization or reaction during temperature exposure to the epoxy resin formulation is significantly inhibited. No change results in the epoxy resin formulation when processed at elevated temperatures for a prolonged period of time. The rheological properties of the obtained composition are not changed. As a result, the quality of the prepregs or towpregs produced with the epoxy resin compositions is also not affected.

TABLE 2
Reactivity of epoxy resin compositions in comparison

| | Ref. 2 | G | H |
|---|---|---|---|
| Formulations | | | |
| EPIKOTE ™ Resin 828 | 100 | 100 | 100 |
| DYHARD ® 100S | 6.5 | 6.5 | 6.5 |
| Urea 1 | 3.0 | 3.0 | 3.0 |
| 1-octylboronic acid | | 0.2 | 0.4 |
| Dynamic DSC | | | |
| Onset Temp [° C.] | 138 | 142 | 144 |
| Peak Temp [° C.] | 145 | 149 | 151 |
| Isothermal DSC; 2 h at 120° C. | | | |
| Time to 90% turnover [min] | 23 | 28 | 33 |
| Isothermal DSC; 1 hr at 140° C. | | | |
| Time to 90% turnover [min] | 12 | 12 | 14 |

Temperature exposure 1 h @ 80° C.

| | | | |
|---|---|---|---|
| Dynamic DSC | | | |
| Onset Temp [° C.] | 125 | 140 | 145 |
| Peak Temp [° C.] | 137 | 148 | 151 |
| Isothermal DSC; 2 h at 120° C. | | | |
| Time to 90% turnover [min] | 17 | 25 | 29 |
| Isothermal DSC; 1 hr at 140° C. | | | |
| Time to 90% turnover [min] | 8 | 10 | 11 |

Description and Evaluation of the Results from Table 2:

Examples G and H as well as comparative example Ref. 2 describe epoxy resin compositions consisting of curing agent and curing accelerator in a commercially available epoxy resin, with and without substituted boronic acid, respectively. Examples G and H as well as Ref. 2 were subjected to temperature exposures typical for prepreg and towpreg production. Subsequently, the obtained epoxy resin compositions were analyzed by dynamic DSC and isothermal DSC.

The examples show that after temperature exposure, examples G and H according to the invention do not result in any influence on the properties of the epoxy resin formulation compared to comparative example Ref. 2.

After a temperature exposure of 1 h at 80° C., comparative example Ref. 2 shows an onset temperature reduction of 9% (12° C.) and a peak temperature shift of 6% (8° C.) to lower temperature in the dynamic DSC examination. In examples G to H according to the invention, there is no significant onset or peak temperature reduction after temperature exposure.

By means of isothermal DSC analysis at 140° C. for 1 h, a reduction in the conversion time of 33% (4 min) is measured in comparative example Ref. 2 after previous temperature exposure, and at 120° C. for 2 h a reduction of 26% (6 min). By using the substituted boronic acid in examples G and H, a reduction in the conversion times is also observed in the isothermal DSC analyses. However, these are significantly shorter than in Ref. 2. As expected, increasing the proportion of the accelerator in the epoxy resin composition increases its reactivity. Examples G and H show that the addition of the substituted boronic acid nevertheless significantly reduces the influence of the temperature on the epoxy resin composition.

In summary, even at increased accelerator rates, the use of substituted boronic acid in Examples G and H effectively inhibits polymerization and reaction, respectively, during temperature exposure to formulate the epoxy resin formulation.

TABLE 3
Reactivity of epoxy resin compositions in comparison

| Formulations | Ref. 3 | J | K | Ref. 4 | L | M |
|---|---|---|---|---|---|---|
| Resin 1 | 100 | 100 | 100 | 100 | 100 | 100 |
| D.E.R. 337 | | | | | | |
| DYHARD ® 100S | 4.9 | 4.9 | 4.9 | 5.1 | 5.1 | 5.1 |
| Urea 1 | 1.0 | 1.0 | 1.0 | 1.0 | 1.0 | 1.0 |
| 3-Fluorophenylboronic acid | | 0.2 | 0.4 | | 0.2 | 0.4 |
| Dynamic DSC | | | | | | |
| Onset Temp [° C.] | 140 | 146 | 146 | 140 | 144 | 147 |
| Peak Temp [° C.] | 149 | 155 | 155 | 150 | 155 | 157 |
| Isothermal DSC; 2 h at 120° C. | | | | | | |
| Time to 90% turnover [min] | 41 | 46 | 47 | 34 | 42 | 56 |

Temperature exposure 3 h @ 60° C.

| | | | | | | |
|---|---|---|---|---|---|---|
| Dynamic DSC | | | | | | |
| Onset Temp [° C.] | 136 | 147 | 148 | 138 | 146 | 152 |
| Peak Temp [° C.] | 146 | 155 | 155 | 149 | 155 | 160 |
| Isothermal DSC; 2 h at 120° C. | | | | | | |
| Time to 90% turnover [min] | 33 | 45 | 46 | 31 | 40 | 56 |

Temperature exposure 1 h @ 80° C.

| | | | | | | |
|---|---|---|---|---|---|---|
| Dynamic DSC | | | | | | |
| Onset Temp [° C.] | 131 | 145 | 147 | 127 | 146 | 151 |
| Peak Temp [° C.] | 143 | 154 | 155 | 143 | 155 | 159 |
| Isothermal DSC; 2 h at 120° C. | | | | | | |
| Time to 90% turnover [min] | 32 | 45 | 48 | 28 | 41 | 54 |

Description and Evaluation of the Results from Table 3:

Examples J, K, L, M and the comparative examples Ref. 3 and Ref. 4 describe epoxy resin compositions consisting of curing agent and curing accelerator in a modified epoxy resin, each with and without substituted boronic acid. The examples were subjected to temperature exposures typical of prepreg and towpreg production. Subsequently, the epoxy resin compositions were analyzed by dynamic DSC and isothermal DSC.

After temperature exposure for 3 h at 60° C., the obtained epoxy resin compositions are characterized by means of dynamic DSC. Comparative example Ref. 3 and Ref. 4, respectively, show an onset temperature decrease of 3% (4° C.) and 1% (2° C.), respectively, and a peak temperature shift of 2% (3° C.) and below 1% (1° C.) to lower temperature, respectively, after temperature exposure. Epoxy resin formulations of examples J and K or L and M according to the invention show no onset or peak temperature decrease after measurement.

At an isothermal temperature for 2 h at 120° C., the turnover time decreases by 20% (8 min) in Ref.3 and by 9% (3 min) in Ref. 4. By using the substituted boronic acid, no significant changes in the turnover time can be observed in the isothermal DSC measurement in examples J, K (compared to Ref. 3) and M (compared to Ref. 4). Example L shows a slightly smaller decrease in turnover time than Ref. 4.

After a temperature exposure of 1 h at 80° C., the dynamic DSC measurement showed that Ref. 3 and Ref. 4, respectively, experience an onset temperature decrease of 6% (9° C.) and 9% (13° C.) and a peak temperature shift of 4% (6° C.) and 5% (7° C.) to lower temperatures. No significant onset or peak temperature decrease is detected in the examples according to the invention. At an isothermal temperature of 2 h at 120° C., the turnover time decreases by 22% (8 min) in ref. 3 and 18% (7 min) in Ref. 4. By using the substituted boronic acid, no significant changes in the turnover times can be detected in the isothermal DSC measurement in examples J and K and I and M, respectively.

Also in the case of modified resins, the substituted boronic acids of Examples J, K, L and M provide sufficient inhibition of polymerization or reaction during temperature exposure in the preparation of the corresponding epoxy resin formulations. The quality of such resin formulations is maintained and thus the quality of the pre-impregnated materials, such as prepregs and towpregs.

1. A method for the preparation of an epoxy resin composition for the pre-impregnation of materials, comprising:
a) heating the epoxy resin to a temperature in the range of 60° C. to 100° C.;
b) mixing a boronic acid of the general formula (I) with the epoxy resin as a polymerization retarder, wherein formula (I) is: 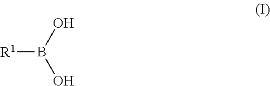
wherein residue R¹ is:
R¹=alkyl, hydroxyalkyl or a residue of formula (II), wherein formula (II) is: 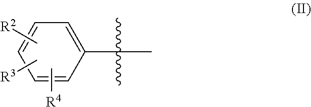
wherein residues R², R³, and R⁴ are independent of one another, and at least one residue R², R³, R⁴ is not hydrogen:
wherein R², R³, and R⁴=hydrogen, fluorine, chlorine, bromine, iodine, cyano, C₁- to C₅-alkyl, alkoxy, acyl, alkylsulfonyl, aryl, carboxyl or B(OH)₂,
c) mixing a curing accelerator with the epoxy resin to accelerate curing of the epoxy resin, wherein the curing accelerator comprises a compound of formula (III) 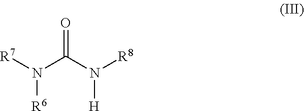
wherein R⁶, R⁷, R⁸ independently of one another are:
R⁶, R⁷=independently of one another hydrogen or C₁- to C₅-alkyl,
hydrogen, C₁- to C₁₅-alkyl, C₃- to C₁₅-cycloalkyl, aryl, R⁸=alkylaryl,
C₁- to C₁₅-alkyl substituted with —NHC(O)NR⁶R⁷,
C₃- to C₁₅-cycloalkyl substituted with —NHC(O)NR⁶R⁷,
aryl substituted with —NHC(O)NR⁶R⁷ or
alkylaryl substituted with —NHC(O)NR⁶R⁷,
d) optionally, mixing a curing agent with the epoxy resin, the curing agent comprising cyanamide and/or a compound of formula (IV), and 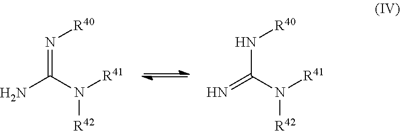
wherein residues R⁴⁰, R⁴¹, R⁴² independently of one another are:
R⁴⁰=cyano, nitro, acyl or a residue of the formula —(C═X)—R⁴³, wherein X=Imino or oxygen,
R⁴³=amino, alkylamino or alkoxy,
R⁴¹=hydrogen, C₁- to C₅-alkyl, aryl or acyl,
R⁴²=hydrogen or C₁- to C₅-alkyl
e) optionally, mixing a thickening agent with the heated epoxy resin from step a),
wherein the temperature exposure to the epoxy resin according to step a) is at least 15 min and must not exceed 240 min, and wherein two or more of the method steps a) to e) can be carried out simultaneously and/or successively.

2. Method according to claim 1, wherein the epoxy resin is heated in method step a) to a temperature in the range from 70° C. to 90° C.

3. Method according to claim 1, wherein the epoxy resin containing the curing accelerator and optionally the curing agent, but not the polymerization retarder and thickener, has an onset temperature between 110 and 150° C. and/or a peak temperature between 120° C. and 160° C. after a temperature exposure of 80° C. for 1 h, the onset temperature and the peak temperature being determined by dynamic DSC measurement at a temperature of −30° C. to 250° C. with a heating rate of 10° C./min.

4. Method according to claim 1, wherein the epoxy resin composition, after a temperature exposure of 80° C. for one hour, has an onset temperature and/or a peak temperature at least 5% to at most 20% higher than for a corresponding epoxy resin without polymerization retarder, the onset temperature and the peak temperature being determined by dynamic DSC measurement at a temperature of −30° C. to 250° C. with a heating rate of 10° C./min.

5. Method according to claim 1, wherein the epoxy resin composition after a temperature exposure of 80° C. for one hour deviates the onset temperature by at most 3.5% from the onset temperature of the corresponding epoxy resin composition without temperature exposure, and/or after temperature exposure of 80° C. for one hour, the peak temperature deviates by at most 3% from the peak temperature of the corresponding epoxy resin composition without temperature exposure, wherein the onset temperature and the peak temperature are determined by dynamic DSC measurement at a temperature of −30° C. to 250° C. with a heating rate of 10° C./min.

6. Method according to claim 1, wherein the thickener is selected from the group of thermoplastic polymers such as including phenoxy resins, acrylate polymers, acrylonitrile polymers, polyetherimide polymers, polyetherketone polymers, polysulfone polymers and/or powdery inorganic thickeners according to method step e).

7. Method according to claim 1, wherein residue R¹ in formula (I) is selected from the group of residues methyl, ethyl, n-propyl, 1-methylethyl, n-butyl, 1-methylpropyl, 2-methylpropyl, n-pentyl, n-hexyl, n-heptyl, n-octyl, n-nonyl, n-decanyl, hydroxymethyl, 2-hydroxyethyl, 3-hydroxypropyl, 4-hydroxybutyl or 5-hydroxypentyl.

8. Method according to claim 1, wherein R¹ in formula (I) is a residue of formula (II) wherein at least one of residues R², R³ and R⁴ is a residue selected from the group consisting of fluorine, chlorine, bromine, iodine, cyano, C₁- to C₅-alkyl, alkoxy, acyl, alkylsulfonyl, aryl, carboxyl and B(OH)₂.

9. Method according to claim 1, wherein the epoxy resin composition prepared based on 100 parts by weight of epoxy resin comprises;
a) 0.05 to 3.0 parts by weight of boronic acid according to formula (I),
b) 0.1 to 9 parts by weight of curing accelerator according to formula (III), and
c) 1 to 15 parts by weight of curing agent according to formula (IV).

10. Method according to claim 1, wherein a weight ratio of curing agent to boronic acid in the range from 1:1 to 240:1, and/or a weight ratio of curing accelerator to boronic acid in the range from 0.05:1 to 160:1 is used.
